(19) United States
(12) Patent Application Publication
(10) Pub. No.: US 2009/0287428 A1
(43) Pub. Date: Nov. 19, 2009

(54) FRACTIONAL SAMPLES TO IMPROVE METERING AND INSTRUMENTATION

(75) Inventors: Scott Turner Holdsclaw, Raleigh, NC (US); Charlie Edgar Minton, III, Willow Spring, NC (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: ELSTER ELECTRICITY, LLC, Raleigh, NC (US)

(21) Appl. No.: 12/119,919

(22) Filed: May 13, 2008

(51) Int. Cl. G06F 19/00

(52) U.S. Cl. 702/57

(57) ABSTRACT

Methods and devices to determine values relating to metering a power line signal. A power line signal may be sampled by defining accumulation intervals associated with the power line signal. An accumulation interval may comprise sample periods. Samples are taken during sample periods. Values associated with the samples are determined for each sample period. A sample period may be associated with one or more accumulation intervals. When a sample period belongs to one accumulation interval, the sample period may be allocated to the one accumulation interval. When a sample period is associated with more than one accumulation interval, portions of the sample period may be allocated to the accumulation intervals to which the portions belong. Values determined for a sample period may be allocated to one or more accumulation intervals by allocating the values in relation to the allocation of the sample periods.

### BACKGROUND

Much of the transmission and distribution of electrical energy over power lines is done at some nominal frequency, typically at 50 or 60 Hz. Historically, small variations in the nominal line frequency were of little concern to electromechanical watthour metering. Electromechanical meters were limited to basic metrics such as watthours or VARhours using phase shifting transformers, and the accuracy of the results were not generally dependent on frequency.

The recent deregulation of the utility industry has created a market for products that facilitate the efficient distribution and monitoring of electrical power. In addition to increased customer demand and deregulation, the advent of electronic energy meters has allowed such analysis to be processed and displayed by the meter. For example, electronic meters are capable of determining many characteristics on the power line including: phase angles from one voltage to another voltage, phase angles from a current to a voltage, per phase power factors, per phase voltages, per phase currents, per phase voltage harmonics, per phase current harmonics, per phase and system watts, per phase and system volt-amperes, per phase and system volt-amperes reactive, total harmonic distortion for per phase voltages and current, reactive energy (VARhours), apparent energy (Volt-Ampere hours), volt-squared hours, amp-squared hours, and line frequency. Also, new quantities may be added without necessarily having to change hardware, but by simply changing software used to process the digital input signals.

Previously, electronic meters were subject to certain limitations in the way in which power line values were sampled. For example, calculations that require the number of samples accumulated to be tied to a set number of line cycles were difficult to determine. This is due, in part, to the inherent and varied fluctuations that occur around a nominal frequency, like 60 Hz. More specifically, although the United States power system is said to operate at a nominal frequency of 60 Hz, in practice the actual transmitted frequency is rarely exactly 60 Hz and instead typically varies around 60 Hz. As a result, it was very difficult for any fixed sample rate to guarantee that it had sampled a whole number of line cycles. Instead, the first sample typically included a portion of the previous and undesirable line cycle that was not part of the overall calculation. And the last sample included a portion of the subsequent and undesired line cycle that was not part of the overall calculation. Therefore, when certain calculations required one or more integer line cycles, it became necessary either to compensate for the expected inability to ensure that the integer number of line cycles could be contained within an integer number of samples, or to accept errant results for that specific accumulation interval.

An accumulation interval may vary from as short as ¼ to ½ line cycle (e.g., for rms measurements), to multiple seconds, but generally vary from 1 cycle to 1 second. When simply accumulating data and then dividing by the integer number of samples accumulated, there may be inherent tradeoffs. Accurate average values may be calculated for a short time period (for example, 1 line cycle), where the time per sample may be evenly divisible into the time of the cycle. If it is not evenly divisible, either too many samples or too few samples may be accumulated and the average results may be in error. Most electronic meters have fixed sample rates, but may be required to handle variations in line frequency. As a result, there may be no way to approximate an exact number of samples per line cycle under all conditions.

One solution may be to increase the fixed sample rate. This may give better results by decreasing the contribution of the fraction of a sample that does not belong to the accumulation interval. However, this may require more processing power in the processor being used to process the increased number of “per sample” calculations. Another method may be to make the accumulation interval much longer. This may reduce the error caused by the inclusion of the fractional portions of a line cycle, but may delay the availability of averaged results for much longer time periods. This may result in the meter's energy pulse outputs not responding to changing conditions within an acceptable time period, and possibly not being able to respond with all the different “per cycle” instrumentation results as noted above in a timely manner. Both methods above may increase the total number of samples in the accumulation interval to achieve the improved accuracy.

Therefore, it should be appreciated that there is a need for providing more accurate techniques for measuring electrical power line characteristics over short accumulation intervals like one line cycle.

### SUMMARY

In an electrical system, an energy meter may measure and calculate parameters associated with a power line signal. In order to measure and calculate such parameters, the embodiments may define an accumulation interval associated with a power line signal. For example, an accumulation interval may include one or more line cycles.

Samples of a power line signal may be taken during sample periods. The embodiments may use one or more samples to determine (e.g., read or calculate) a value associated with a sample period.

A sample period may be associated with one or more accumulation intervals. A sample may be taken during an intervening sample period or a last sample period. An intervening sample period belongs to a present accumulation interval. A last sample period may comprise a present portion that belongs to a present accumulation interval. A last sample period may also comprise a subsequent portion that belongs to a subsequent accumulation interval. The embodiments may approximately allocate sample periods and sample period portions to accumulation intervals to which the sample periods or sample period portions belong. A value associated with a sample period may be allocated to one or more accumulation intervals in relation to an allocation of the sample period with which the value is associated.

### BRIEF DESCRIPTION OF THE DRAWINGS

FIG. 1 is a block diagram of an electronic meter for measuring electrical parameters associated with a power line signal.

FIG. 1A illustrates an exemplary periodic power line signal and related measuring parameters.

FIG. 2 is a diagram illustrating a method of tracking sample quantity, determining whether a transition is made to a new accumulation interval and allocating samples or sample portions associated with an accumulation interval.

FIG. 3 is a diagram illustrating end of interval calculations.

FIG. 4 is a diagram illustrating the processing of final accumulation values of a present accumulation interval.

FIG. 5 is a diagram illustrating the calculation and loading of initial accumulation values for a subsequent accumulation interval.

FIG. 6 is a diagram illustrating the calculation of average values for a present accumulation interval.

### DETAILED DESCRIPTION

Most solid state or electronic electrical energy meters digitally sample voltage and current signals on one to three different phases, and process them to typically generate quantities for billing purposes. The meters typically measure basic power quantities like watthours, VARhours or VAhours. The electronic electrical energy meters also have become capable of conducting a variety of instrumentation and/or power line performance determinations. For example, these meters may be capable of determining the validity of the wiring external to the electronic meter itself, and other power line parameters, such as harmonics.

Systems and methods describing the novel techniques will now be described with reference to the Figures. It will be appreciated by those of ordinary skill in the art that the description given herein with respect to those Figures is for exemplary purposes only and is not intended in any way to limit the scope of the embodiment. For example, although an example meter may be used for illustration, it should be appreciated that this meter is merely provided for the purpose of clearly describing the methods and systems. However, this discussion is not intended to limit the disclosed embodiments. In fact, the disclosed techniques are equally applicable to other meters and metering systems.

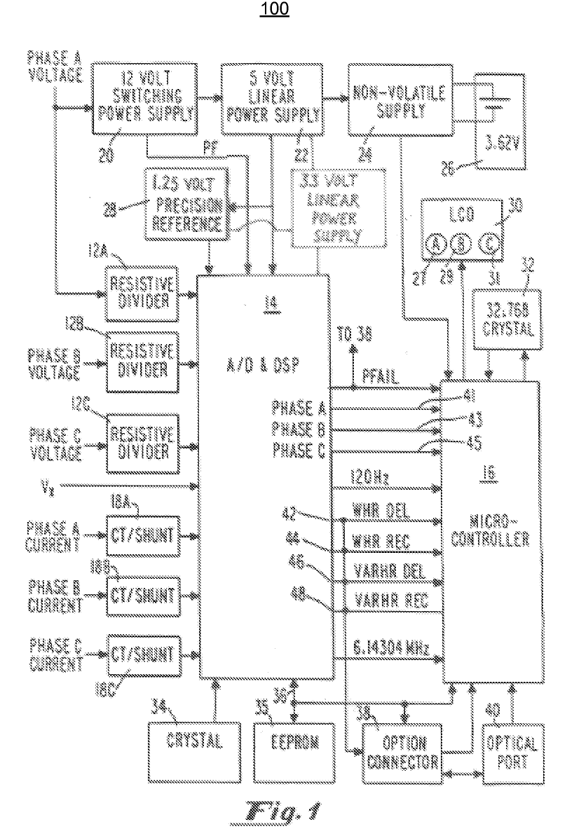

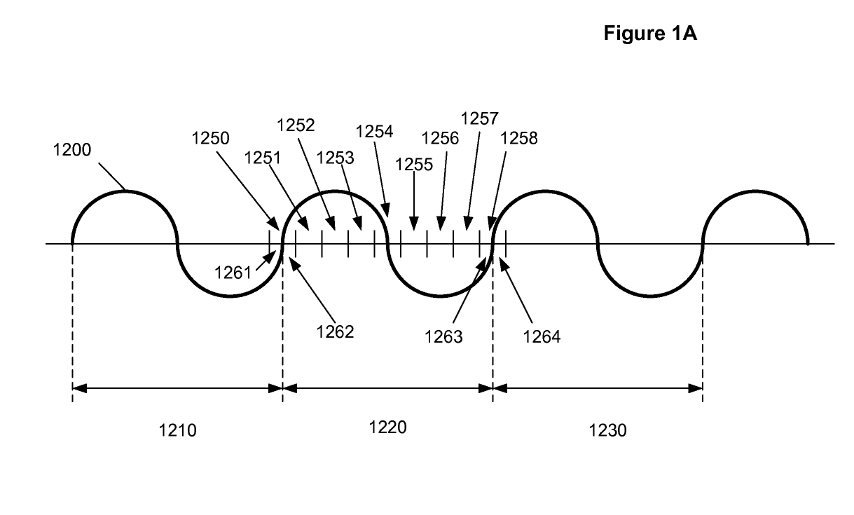

FIG. 1 is a block diagram showing the functional components of an example meter and their interfaces. As shown in FIG. 1, a meter 100 for metering three-phase electrical energy includes a digital LCD type display 30, a meter integrated circuit (IC) 14 which comprises A/D converters and a programmable digital signal processor (DSP), and a microcontroller 16. Analog voltage and current signals propagating over power distribution lines between the power generator of the electrical service provider and the users of the electrical energy are sensed by voltage dividers 12A, 12B, 12C and current transformers or shunts 18A, 18B, 18C, respectively.

The outputs of the resistive dividers 12A-12C and current transformers 18A-18C, or sensed voltage and current signals, are provided as inputs to the meter IC 14. The A/D converters in the meter IC 14 convert the sensed voltage and current signals into digital representations of the analog voltage and current signals. In a preferred embodiment, the A/D conversion is carried out as described in U.S. Pat. No. 5,544,089, dated Aug. 6, 1996, and entitled “Programmable Electrical Meter Using Multiplexed Analog-To-Digital Converters”, which is herein incorporated by reference. The digital voltage and current signals are then input to the programmable DSP in the meter IC 14 for generating pulsed signals 42, 44, 46, 48 representing various power measurements, that is, each pulse may represent the Ke value associated with Watts, VAs, or VARs. These pulsed signals may be processed by microcontroller 16 to perform revenue metering functions for billing purposes.

The microcontroller 16 preferably interfaces with the meter IC 14 and with one or more memory devices through a serial communications bus 36. A memory, preferably a non-volatile memory such as an EEPROM 35, is provided to store nominal phase voltage and current data and threshold data as well as programs and program data. Upon power up after installation, a power failure, or a data altering communication, for example, selected data stored in the EEPROM 35 may be downloaded to the program RAM and data RAM associated within the meter IC 14, as shown in FIG. 1. The DSP under the control of the microcontroller 16 processes the digital voltage and current signals in accordance with the downloaded programs and data stored in the respective program RAM and data RAM.

To perform line frequency measurements and compensation, the meter IC 14 monitors the line frequency over, for example, multiple line cycles. It should be understood that the number of line cycles is preferably programmable and a different number of line cycles may be used for designated measurements. In fact, using the disclosed techniques it may be possible to perform some of the power line measurements and analysis using less than one full line cycle.

It should also be appreciated that meter 100 also provides for remote meter reading, remote power quality monitoring, and reprogramming through an optical port 40 and/or an option connector 38. Although optical communications may be used in connection with the optical port 40, option connector 38 may be adapted for RF communications or electronic communications via a modem, for example.

The disclosed techniques may be in firmware, wherein such operations are enabled by the correct programming of data tables. However, it should also be appreciated that the disclosed techniques also may be using software and/or hardware, or in a combination of the two. In fact, the disclosed techniques are not limited to any particular implementation but contemplate implementation in any tangible form.

Following power-up at installation, a service test may be performed to identify and/or check the electrical service. The meter may be preprogrammed for use with a designated service or it may determine the service using a service test. When the service test is used to identify the electrical service, an initial determination is made of the number of active elements. To this end, each element (i.e., 1, 2, or 3 elements) may be checked for voltage. Once the number of elements is identified, many of the service types can be eliminated from the list of possible service types. The voltage phase angle relative to phase A (or any other phase) may then be calculated and compared to each phase angle for a-b-c or c-b-a rotations with respect to the remaining possible services. If a valid service is found from the phase angle comparisons, the service voltage may be determined by comparing the rms voltage measurements for each phase with nominal phase voltages for the identified service. If the nominal service voltages for the identified service matches measured values within an acceptable tolerance range, a valid service is identified and the phase rotation, service voltage, and service type may be displayed. The service may be locked, i.e., the service information is stored in a memory, preferably a non-volatile memory, such as the EEPROM 35, manually or automatically. There are a variety of possible service types including 4-wire wye, 3-wire wye, 4-wire delta, 3-wire delta, or single phase, just to name a few.

When the service type is known in advance and locked, the service test may check to ensure that each element is receiving phase potential and that the phase angles are within a predetermined percentage of the nominal phase angles for the known service. The per-phase voltages also may be measured and compared to the nominal service voltages to determine whether they are within a predefined tolerance range of the nominal phase voltages. If the voltages and phase angles are within the specified ranges, the phase rotation, service voltage, and service type may be displayed on the meter display. If either a valid service is not found or the service test for a designated service fails, a system error code indicating an invalid service may be displayed and locked on the display to ensure that the failure is noted and evaluated to correct the error.

After service detection or verification, additional functionality may also be required of the meter. Power quality monitoring may use instrumentation request results to perform tests of actual conditions against preset thresholds. Many power quality tests may be used, requiring fast and accurate instrumentation. Voltage sag and swell monitoring is another instrumentation function that may need to be performed over a short period. Response times may be 1 to 2 line cycles, but may go as low as either ½ or ¼ of a line cycle. Additionally, instrumentation profiling may be required which reads and records instrumentation values over time. But within individual instrumentation profiling periods, many instrumentation readings may occur, and a variety of different results may actually be stored in the profile data. These different results may include the first or last reading of the interval, the minimum or maximum reading from the interval, the average of all readings over the interval, etc. Fast reading results may be necessary in order to be able to profile many different quantities at the same time. Accuracy may also be important (e.g., where minimum or maximum reading results are stored—which could record any errant instrumentation readings).

Instrumentation results typically include two types of groups, “per sample” and “per cycle.” The “per sample” results may have calculations specific to the instrumentation requests that may be performed during a sample time. The “per cycle” results may generally be the average of one or more accumulation intervals. The accumulation interval may be the period over which individual voltage and current samples are read from the analog to digital converters (ADCs), phase shifted if required, multiplied together to calculate watts and VARs (volt-amperes reactive), squared to calculate the basis for rms (root mean squared) values, etc. Values summed over an accumulation interval may be divided by the number of samples taken within the accumulation interval to obtain an average per sample value for various quantities (watts, VARs, mean squared voltage, mean squared current, etc.). Additional processing of these values may generate rms voltages and currents as well as volt-amperes (VA) and other values.

The disclosed embodiments allocate a value associated with a sample period to one or more associated accumulation intervals. FIG. 1A illustrates an exemplary power line signal 1200, accumulation interval 1210, accumulation interval 1220, accumulation interval 1230, sample periods 1250-1258 and sample period portions 1261-1264. The exemplary power line signal 1200 may be a periodic wave as shown in FIG. 1A. An accumulation interval may be a period for which samples, and values associated with the samples, are accumulated. For illustration purposes, accumulation interval 1220 may be defined as one line cycle of exemplary power line signal 1200 starting from one positive voltage zero crossing to the next positive voltage zero crossing, as may accumulation interval 1210 and accumulation interval 1230. However, the foregoing definition of an accumulation interval is exemplary. An accumulation interval may be defined in any manner, including but not limited to fractional line cycles, multiple line cycles, non-integer multiple line cycles, etc.

Samples may be taken during sample periods. Samples that may be taken during a sample period include voltage and current samples. For example, a voltage sample may be taken during each of the sample periods 1250-1258.

When a sample period includes a portion in one accumulation interval and a portion in another accumulation interval, the portions may be approximately allocated to the accumulation intervals to which the portions belong. For example, sample period 1258 has a portion 1263 that belongs to accumulation interval 1220 and a portion 1264 that belongs to accumulation interval 1230. In addition, sample period 1250 has a portion 1261 that belongs to accumulation interval 1210 and a portion 1262 that belongs to accumulation interval 1220. When one accumulation interval ends and another begins the change may be referred to as a transition.

A sample period that belongs to a single accumulation interval may be referred to as an intervening sample period. For example, sample periods 1251 through 1257 may be intervening sample periods each belonging to accumulation interval 1220. The samples associated with sample periods 1251 through 1257 may also belong to accumulation interval 1220 and may be referred to as intervening samples.

Sample period 1258 may be considered the last sample period for accumulation interval 1220. When calculating final values for accumulation interval 1220, portion 1263 may be considered a present portion and accumulation interval 1220 a present accumulation interval. In addition, portion 1264 may be considered a subsequent portion, that is, portion 1264 may be associated with subsequent accumulation interval 1230. Further, when calculating final values for accumulation interval 1220, portion 1262 may be referred to as a previous subsequent portion because portion 1262 may be a subsequent portion of the last sample period of previous accumulation interval 1210.

The embodiments may determine (e.g., read, calculate, etc.) a value associated with a sample. In addition, the embodiments may determine a value associated with multiple samples. For example, by multiplying a voltage sample and a current sample, a power value may be determined. Thus, multiple values may be determined for one sample period. Because a sample may be associated with a sample period, a value may be associated with both a sample and a sample period. Further, a value may be referred to as associated with a sample or a sample period.

A value associated with a sample period may be allocated to one or more accumulation intervals in relation to an allocation of the sample period with which the value is associated. Using FIG. 1A for example, each of sample periods 1250-1258 may have associated values. The values may then be allocated in proportion to the allocation of the sample periods. In FIG. 1A, portion 1262, which may be 50 percent of sample period 1250, may be allocated to accumulation interval 1220. Also, portion 1263, which may be 50 percent of sample period 1258, may be allocated to accumulation interval 1220. Because values are allocated in proportion to sample period and sample portion allocation, 50 percent of the value associated with sample period 1250 may be allocated to accumulation interval 1220. In the example of FIG. 1B, the value associated with portion 1262 is 50 percent of the value associated with sample period 1250. In addition, 50 percent of the value associated with sample period 1258 may be allocated to accumulation interval 1220. That is, the value associated with portion 1263 is 50 percent of the value associated with sample period 1258. Because intervening samples periods 1251-1257 belong to accumulation interval 1220, the values associated with intervening samples periods 1251-1257 may be allocated to accumulation interval 1220. Thus, by combining the values associated with portion 1262, intervening samples 1251-1257 and portion 1263, an accurate accumulated value (i.e., the summation of the values belonging to accumulation interval 1220) may be obtained for accumulation interval 1220. Values obtained by this method may allow for accurate instrumentation results over a small number of accumulation intervals.

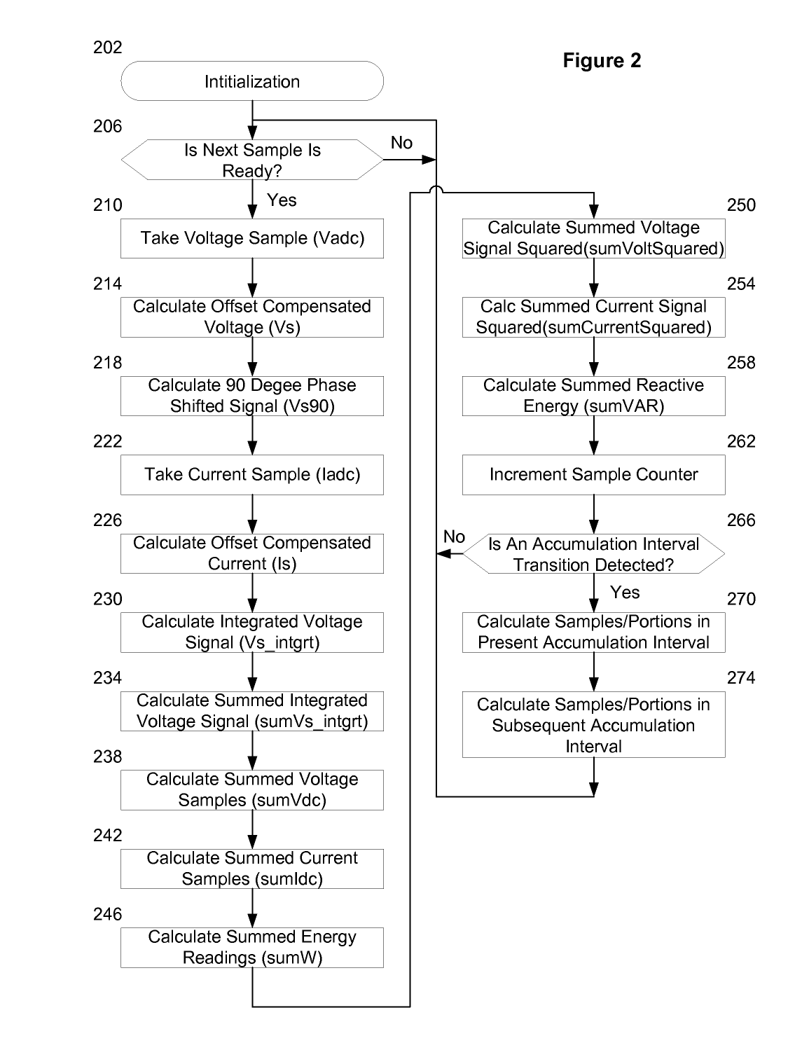

The process of allocating values in relation to allocation of sample periods is described further in FIGS. 2-6. FIG. 2 illustrates a method to determine values that may be associated with a sample, as well as calculations associated with the accumulation process (e.g.,, summation). The method illustrated in FIG. 2 also describes tracking sample quantity, determining whether a transition is made to a new accumulation interval and allocating samples or sample portions associated with an accumulation interval. The exemplary method uses electrical parameters for a single phase of voltage and current. However, the exemplary method is not intended to be limiting. The exemplary method may be used with single phase meters, polyphase meters as well as other meters.

At 202, parameters (e.g., values) that may be measured or calculated may be initialized to a zero value. Many parameters may be initialized to a zero value including sumVdc, sumIdc, sumW, sumVoltSquared, sumCurrentSquared, sumVAR, sumVs_intgrt, OV, OI, OV_intgrt and Tx. The parameter sumVdc may be used to accumulate the sum of the voltage samples over an accumulation interval to be used for DC offset calculations. The parameter sumIdc may be used to accumulate the sum of the current samples over an accumulation interval to be used for DC offset calculations. The parameter sumW may be used to accumulate products from the multiplication of the voltage sample and the current sample over an accumulation interval to be used for active energy calculations. The parameter sumVoltSquared may be used to accumulate products from the squaring of the voltage sample over an accumulation interval to be used for rms voltage calculations. The parameter sumCurrentSquared may be used to accumulate products from the squaring of the current sample over the accumulation interval to be used for rms current calculations. The parameter sumVAR may be used to accumulate products from the multiplication of a voltage sample and a current sample (one of which has been phase shifted by 90 degrees) over the accumulation interval to be used for reactive energy calculations. The parameter sumVs_intgrt may be used to accumulate an integrated voltage value which may be used in VAR calculations. Integration may be used to implement a 90 degree phase shift of a signal for use in VAR calculations, and although it is done to the voltage in this embodiment, it is contemplated for use in current as well. The parameter OV may be used as an offset to the voltage signal which is removed from each voltage sample to cancel any DC component to the signal. The parameter OT may be used as an offset to the current signal which is removed from each current sample to cancel any DC component to the signal. The parameter OV_intgrt may be used as an offset to the integrated signal which is removed from integrated signal each sample time to cancel any DC component to the signal. The parameter Tx may be used as the sample counter to determine the length of the accumulation interval.

At 206, a determination is made whether the next set of voltage and current samples is available. If the next set of voltage and current samples is not available, a new determination is made until the next set of samples is ready. When the next set of voltage and current samples is available, a voltage sample (Vadc) is taken at 210. Vadc may be sampled at an ADC. At 214, a DC offset voltage (OV) may be removed from Vadc creating offset compensated voltage (Vs), where Vs=Vadc−OV. At 218, a 90 degree phase shifted signal (Vs90) is calculated. Vs90 is calculated from the difference of the present voltage sample and the previous voltage sample resulting in Vs90 being shifted approximately 90 degrees from Vs. At 222, a current sample (Iadc) is taken. Iadc may be sampled at an ADC. At 226, a DC offset current (OI) may be removed from Iadc creating an offset compensated current (Is), where Is=Iadc−OI.

At 230, an integrated voltage signal (Vs_intgrt) is calculated by adding the offset compensated voltage of the present sample to the value of the integrated voltage signal from the previous sample, and removing the integrated DC offset voltage (OV_intgrt) from the integrated value (Vs_intgrt=Vs_intgrt (previous)+Vs−OV_intgrt). At 234, a summed integrated voltage signal (sumVs_intgrt) is accumulated, by a summation register for example, where sumVs_intgrt is equal to the value of sumVs_intgrt taken from the previous sample added to Vs_intgrt (sumVs_intgrt=sumVs_intgrt(previous)+Vs_intgrt). The value sumVs_intgrt may be used to calculate the DC offset of the integrated signal.

At 238, sumVdc accumulates the sum of the voltage samples over the accumulation interval, where sumVdc is equal to the value of sumVdc taken from the previous sample added to Vs (sumVdc=sumVdc(previous)+Vs). The value sumVdc may be used to calculate the DC offset of the voltage signal Vs. At 242, sumIdc accumulates the sum of the current samples over the accumulation interval, where sumIdc is equal to the value of sumIdc taken from the previous sample added to Is (sumIdc=sumIdc(previous)+Is). The value sumIdc may be used to calculate the DC offset of the current signal Is. At 246, sumW accumulates the sum of the energy readings (e.g., voltage sample times current sample) over the accumulation interval. SumW equals sumW from the previous sample plus the product of Vs and Is (sumW=sumw(previous)+(Vs*Is)).

At 250, a summation of the voltage signal squared product (sumVoltSquared) is calculated, which may be used for calculation of rms voltage for example. The value sumVoltSquared equals sumVoltSquared from the previous sample plus the product of Vs and Vs (sumVoltSquared=sumVoltSquared(previous)+(Vs*Vs)). At 254, a summation of the current signal squared product (sumCurrentSquared) is calculated, which may be used for calculation of rms current for example. The value sumCurrentSquared equals sumCurrentSquared from the previous sample plus the the product of Is and Is (sumCurrentSquared=sumCurrentSquared(previous)+(Is*Is)).

At 258, a summation of the voltage times current product, where one of the samples is phase shifted by 90 degrees (sumVAR) is calculated, which may be used for calculation of reactive energy for example. The value sumVAR equals sumVAR from the previous sample plus the product of Is and Vs90 (sumVAR=sumVAR(previous)+(Is*Vs90)). The value of sumVAR may also equal sumVAR from the previous sample plus the product of Is and Vs_intgrt (sumVAR=sumVAR(previous)+(Is*Vs_intgrt)). It may be appreciated by one skilled in the art that there are multiple ways to implement the 90 degree phase shift for the VAR calculation, and VAR calculations are not limited to the calculations recited herein.

At 262, a sample counter (Tx) is incremented by one (Tx=Tx+1). Tx may be used to keep track of the number of samples that are accumulated over the accumulation interval. Accumulation intervals may be defined in many different ways. For illustration purposes, the accumulation interval may be defined as one line cycle (e.g., the period from one positive voltage zero crossing to the next positive voltage zero crossing). Samples may be associated with one or more accumulation intervals. For example, a sample may be taken where a portion of the sample was taken during one accumulation interval and another portion of the sample was taken during a different accumulation interval, as illustrated in FIG. 1A.

At 266, a determination is made whether a transition from one line cycle to the next line cycle is detected. In the present example, when a transition is made from one line cycle to the next line cycle during a sample period, there may be a portion of the sample period that belongs to the present accumulation interval and a sample portion that belongs to a subsequent accumulation interval (see FIG. 1A). When the accumulation interval is defined as the period from one positive voltage zero crossing to the next positive voltage zero crossing, a transition may be detected by detecting the polarity of Vs of the present sample compared with the polarity of the previous sample. For example, a transition may be detected if the value of the previous sample Vs was negative and the value of the present Vs is not negative. If a transition was not detected, the method resumes at 206. If a transition is detected, then additional end of accumulation interval calculations may be performed, such as those at 270 and 274.

At 270, the final number of samples for the accumulation interval may be calculated (LastTx). LastTx, as well as Tx may not be simply integer counters, but include a fractional portion as well. LastTx is loaded with the present value of Tx, but because a full sample was added to Tx at 262, some fraction of the sample (i.e., a portion) may be removed, which may generate a more accurate representation of the accumulation interval length. The calculation of the portions of the sample that are to be credited to the present interval and the subsequent interval may be performed in many ways.

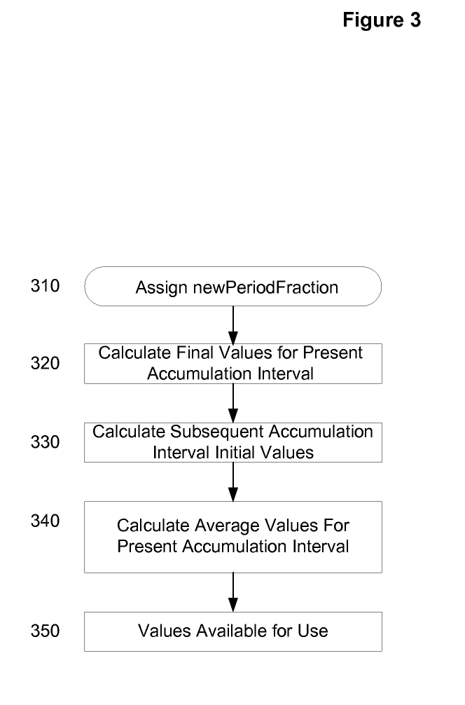

As an illustration, at 270 the calculation may be a linear interpolation between the last two voltage samples (e.g., LastTx=Tx−(Vs_n/[Vs_n−Vs_n−1]). In the above formula Vs_n is the present sample and Vs_n−1 is the previous sample. (Vs_n/[Vs_n−Vsₙ₋1]) represents the fraction of the sample (i.e., portion) that belongs to the subsequent accumulation interval, so this fraction is then subtracted from the LastTx value to give the final LastTx value. Because a new accumulation interval may have already started, the fraction of the sample which belongs to the subsequent accumulation interval is now loaded into Tx at 274. Additional calculations take place as shown in FIG. 3, and the sample accumulation process for the subsequent accumulation interval begins at 206. The process may repeat itself for each accumulation interval.

FIG. 3 illustrates end of interval calculations that may be performed in association with present and subsequent accumulation intervals. As an example, after a last sample period is complete, end of interval calculations for a present accumulation interval may take place. End of interval processing may start with determining a portion of the last sample that belongs to a subsequent accumulation interval.

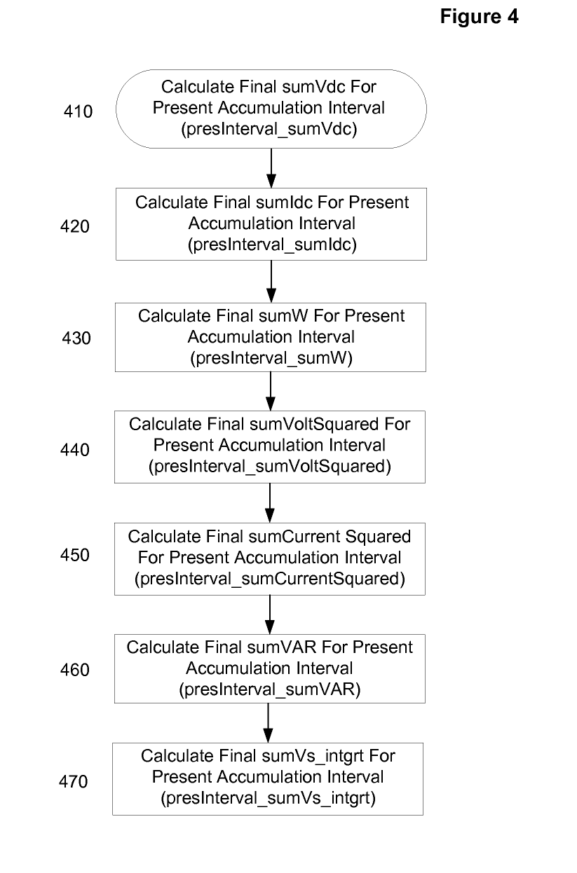

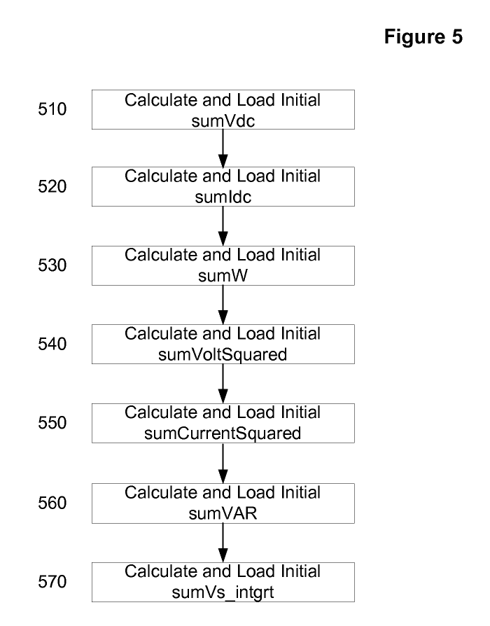

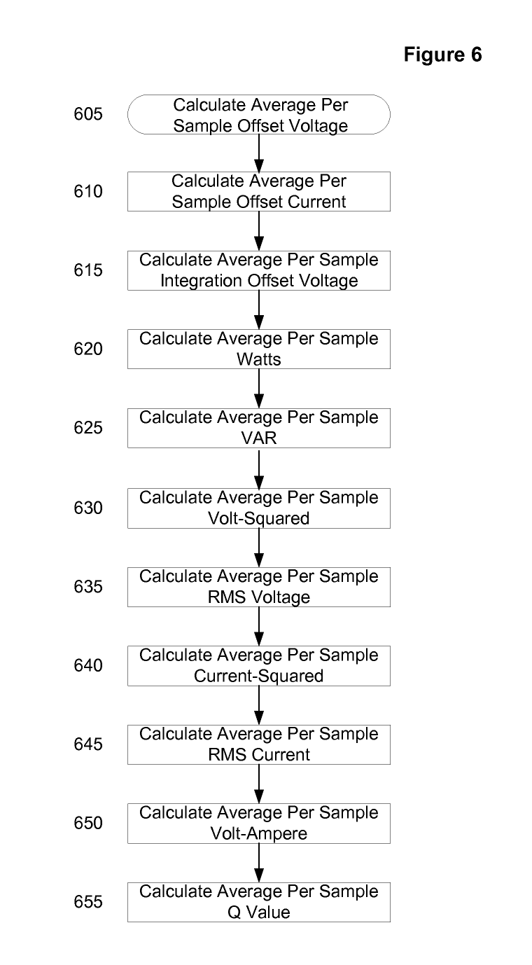

At 310, the new Tx value is copied to another value “newPeriodFraction,” (i.e., newPeriodFraction=Tx). The new Tx value may be in the range 0 to less than 1, so it may be a valid positive fraction. The newPeriodFraction, along with the parameters of FIG. 2, may be used to calculate values for the present accumulation interval. For example, the newPeriodFraction, along with the parameters of FIG. 2, may be used to calculate final values for the present accumulation interval (e.g., FIG. 4), to calculate the subsequent accumulation interval initial values (e.g., FIG. 5), and to calculate average values over the present accumulation interval (e.g., FIG. 6).

At 350, the measured and calculated average values may be available for use for a variety of purposes. Referring back to FIG. 1, the measured and calculated average values may be available for energy related pulse outputs 42,44, 46, and 48, external use through an instrumentation engine over serial communications bus 36, as well as other direct comparisons and outputs such as phase voltage presence indication output lines 41, 43 and 45. An instrumentation engine may be an interface to serially read instrumentation information from the DSP in meter IC 14 to microcontroller 16, where it may be used for additional purposes such as displaying instrumentation values, service detection, power quality monitoring, instrumentation profiling, etc.

When discussing end of accumulation interval calculations, the completed accumulation interval for which calculations are being performed may be referred to as the present accumulation interval, and the following accumulation interval may be referred to as the subsequent accumulation interval. For example, refer to FIG. 1A. When the samples associated with accumulation interval 1220 have been completed, end of interval calculations may begin. When describing the end of interval calculations for accumulation interval 1220, which includes calculating final values for accumulation interval 1220 and initial values for 1230, accumulation interval 1220 is the present accumulation interval and accumulation interval 1230 is the subsequent accumulation interval.

FIG. 4 illustrates calculations that may make parameters valid for the present accumulation interval. That is, the calculations associated with FIG. 4 are examples of using the allocation method described above to provide accurate calculations for the parameters shown. Because the values already had the full last sample value added to them in 234 through 258 in FIG. 2, the fraction of each accumulation that belongs to the subsequent accumulation interval may be subtracted out of each one.

At 410, the final sumVdc value is calculated for the present accumulation interval, which is “presInterval_sumVdc,” (presInterval_sumVdc=sumVdc−(Vs*newPeriodFraction). At 420, the final sumIdc value is calculated for the present accumulation interval, which is “presInterval_sumIdc,” (presInterval_sumIdc=sumIdc−(Is*newPeriodFraction). At 430, the final sumW value is calculated for the present accumulation interval, which is “presInterval_sumW,” (presInterval_sumW=sumW−(Vs*Is*newPeriodFraction). At 440, the final sumVoltSquared value is calculated for the present accumulation interval, which is “presInterval_sumVoltSquared,” (presInterval_sumVoltSquared=sumVoltSquared−(Vs*Vs*newPeriodFraction). At 450, the final sumCurrentSquared value is calculated for the present accumulation interval, which is “presInterval_sumCurrentSquared,” (presInterval_sumCurrentSquared=sumCurrentSquared−(Is*Is*newPeriodFraction). At 460, the final sumVAR value is calculated for the present accumulation interval, which is “presInterval_sumVAR,” (presInterval_sumVAR=sumVAR−(Is*Vs90*newPeriodFraction). At 470, the final sumVs_intgrt value is calculated for the present accumulation interval, which is “presInterval_sumVs_intgrt,” (presInterval_sumVs_intgrt=sumVs_intgrt−(Vs_intgrt*newPeriodFraction)).

FIG. 5 illustrates the initialization of summation registers to begin accumulating data for the subsequent accumulation interval. Values from the present sample period (i.e., values that were used in the present data accumulations) are multiplied by “newPeriodFraction” to calculate the portion of those values that belong to the subsequent accumulation interval. The products may be loaded into the respective accumulation registers to begin data accumulations for the subsequent accumulation interval.

At 510, the initial sumVdc value for the subsequent accumulation interval is calculated (sumVdc=Vs*newPeriodFraction). At 520, the initial sumIdc value for the subsequent accumulation interval is calculated (sumIdc=Is*newPeriodFraction). At 530, the initial sumW value for the subsequent accumulation interval is calculated (sumW=Vs*Is*newPeriodFraction). At 540, the initial sumVoltSquared value for the subsequent accumulation interval is calculated (sumVoltSquared=Vs*Vs*newPeriodFraction). At 550, the initial sumCurrentSquared value for the subsequent accumulation interval is calculated (sumCurrentSquared=Is*Is*newPeriodFraction). At 560, the initial sumVAR value for the subsequent accumulation interval is calculated (sumVAR=Is*Vs90*newPeriodFraction). At 570, the initial sumVs_intgrt value for the subsequent accumulation interval is calculated (sumVs_intgrt=Vs_intgrt*newPeriodFraction).

FIG. 6 illustrates the calculation of average values over the present accumulation interval. For example, data accumulated by various summation registers may be accumulated for the same number of samples, as represented by LastTx. To get the average per sample values, the summations may be divided by LastTx. The average per sample values may then be used for a variety of purposes.

At 605, the average per sample offset voltage is calculated (OV=presInterval_sumVdc/LastTx). The average per sample offset voltage may be used in the subsequent accumulation interval to remove the DC offset from the voltage input signal. At 610, the average per sample offset current is calculated (01=presInterval_sumIdc/LastTx). The average per sample offset current may be used in the subsequent accumulation interval to remove the DC offset from the current input signal. At 615, the average per sample integration offset voltage is calculated (OV_intgrt=presInterval_sumVs_intgrt/LastTx). The average per sample integration offset voltage may be used in the subsequent accumulation interval to remove the DC offset from the integrated voltage input signal.

The calculation of average energy values may also be used. At 620, the value of average per sample watts is calculated (avgw=presInterval_sumW/LastTx). At 625, the value of average per sample VAR is calculated (avgVAR=presInterval_sumVAR/LastTx).

Another group of useful calculations include average per sample rms voltage and current values. At 630, the average per sample volt-squared value is calculated (avgVoltSquared=presInterval_sumVoltSquared/LastTx). When the square root of the average per sample volt-squared value is taken, as at 635, the average per sample rms voltage value, avgVoltage rms, is available (avgVoltage rms=square root (avgVoltSquared)). At 640, the average per sample current-squared value is calculated (avgCurrentSquared=presInterval_sumCurrentSquared/LastTx). When the square root of the average per sample current-squared value is taken, as at 645, the average per sample rms current value, avgCurrent_rms, is available (avgcurrent_rms=square root (avgCurrentSquared)).

Another group of useful calculations include types of energy that are calculated from the prior calculated average per sample quantities. At 650, the average per sample volt-ampere value, avgVoltAmpere, is calculated (avgVoltAmpere=avgVoltage_rms*avgCurrent_rms). In addition, at 655, the average per sample q value, avgQ, is calculated (avgQ=(avgW+[avgVAR*square root (3)])/2). Additional quantities may be calculated from the above average per sample values. The additional quantities include, but are not limited to, transformer compensated energy values, amp-squared values, volt-squared values, alternate VAR calculation methodologies, and even different types of energy summations between different phases (where all phases are accumulated over the same accumulation interval).

Average per sample values, valid for the present accumulation interval, may be available for a variety of purposes. The average energy values may be used to generate output pulses or other types of energy accumulation, which is one purpose of an electricity meter. The average voltages may be used to detect voltage sags and swells, and imbalance conditions. The average currents may be used to detect no load, overload, and imbalance conditions. Measured or calculated values may be available for use by components of meter 100. For example, a measured or calculated average value may be available from the DSP in meter IC 14 over the serial communications bus 36 using the instrumentation engine as the interface mechanism to request and obtain the data. Requests may be made to the instrumentation engine by the microcontroller 16 for uses which may include display of instrumentation values on the LCD 30, determination of the service type to which the meter is connected, power quality monitoring (PQM), instrumentation profiling, requested data from external sources (such as via the optical port), etc. Increased accuracy, which may be obtained from the fractional sampling method, may enhance the performance of power quality tests, or instrumentation profiling. For example, spuriously inaccurate results may cause erroneous failures or failure to detect a valid error. With instrumentation profiling, measured or calculated average values may be monitored over some fixed time period. During that time, analyses may be performed on the values, including average, minimum, maximum, etc. If spuriously inaccurate values occur, they may become more obvious due to minimum or maximum analyses.

As described above, allocating samples or sample portions to the correct accumulation interval may depend on determining when an accumulation interval has ended. For a sample that has portions in both a first accumulation interval and a second accumulation interval, a determination may be made as to what portion of the sample time should be credited to the first accumulation interval and what portion should be accumulated to the second accumulation interval. Determination of the end of an accumulation interval may be performed in a variety of ways. The above example detects a positive zero crossing on a voltage line to determine the beginning and end of an accumulation interval. In addition, the above example uses linear interpolation to calculate the point between the two sample times, i.e., where the first accumulation interval ended and the second accumulation interval began.

However, the embodiments should not be limited to the above examples. The embodiments contemplate other ways to determine when one accumulation interval ends and another begins, and allocating samples accordingly. For example, a determination may be made for a fixed number of sample times, a variable number of sample times that are defined prior to the beginning of the accumulation interval, by a filtered version of the voltage signal, or other possible implementations. Other implementations may use a multipoint non-linear interpolation of actual sample values to accurately approximate the transition point. Another implementation may use predefined fixed accumulation interval lengths, which would allow comparison of the Tx sample counter value to a non-integer sample threshold value for exact calculation of the accumulation interval transition. Other implementations could be used, and will generally vary with respect to the method used to determine which specific sample includes the accumulation interval transition.

What is claimed:

1. A method of determining parameters associated with a power line signal, the method comprising:
collecting a last sample during a last sample period, wherein the last sample period is associated with a present accumulation interval and a subsequent accumulation interval;
detecting a transition during the last sample period from the present accumulation interval to the subsequent accumulation interval; and
determining a present portion of the last sample period that belongs to the present accumulation interval.

2. The method of claim 1, further comprising defining the present accumulation interval.

3. The method of claim 1, further comprising determining a subsequent portion of the last sample period that belongs to the subsequent accumulation interval.

4. The method of claim 3, further comprising determining a last value associated with the last sample.

5. The method of claim 4, wherein a type of the last value is at least one of the following: watts, volt-amperes reactive, voltage-squared, current-squared, voltage, current, integrated voltage, integrated current or accumulation period sample counts.

6. The method of claim 4, further comprising determining a present portion of the last value, wherein the present portion of the last value is determined based upon the determination of the present portion of the last sample period.

7. The method of claim 4, further comprising determining a subsequent portion of the last value, wherein the subsequent portion of the last value is determined based upon the determination of the subsequent portion of the last sample period.

8. The method of claim 6, further comprising adding the present portion of the last value, an intervening value and a previous subsequent portion, wherein the present portion of the last value, the intervening value and the previous subsequent portion are associated with the present accumulation interval, and wherein the intervening value comprises a value determined for an intervening sample, and wherein the intervening sample is associated with an intervening sample period.

9. The method of claim 8, wherein the previous subsequent portion is associated with a previous last sample, and wherein the previous last sample is associated with a previous accumulation interval.

10. The method of claim 6, further comprising adding the present portion of the last value and a previous subsequent portion, wherein the present portion of the last value and the previous subsequent portion are associated with the present accumulation interval.

11. The method of claim 10, wherein the previous subsequent portion is associated with a previous last sample, and wherein the previous last sample is associated with a previous accumulation interval.

12. An electrical energy meter comprising:
a microcontroller, wherein the microcontroller provides instructions; and
a digital signal processor, wherein the digital signal processor receives the instructions, and wherein the digital signal processor comprises at least one subsystem that:
defines an accumulation interval associated with a power line signal;
collects a last sample during a last sample period, wherein the last sample period is associated with a present accumulation interval and a subsequent accumulation interval;
detects a transition during the last sample period from the present accumulation interval to the subsequent accumulation interval; and
determines a present portion of the last sample period that belongs to the present accumulation interval.

13. The electrical energy meter of claim 12, wherein the subsystem determines a subsequent portion of the last sample period that belongs to the subsequent accumulation interval.

14. The electrical energy meter of claim 13, wherein the subsystem determines a last value associated with the last sample.

15. The electrical energy meter of claim 14, wherein a type of the last value may be a at least one of the following: watts, volt-amperes reactive, voltage-squared, current-squared, voltage, current, integrated voltage, integrated current or accumulation period sample counts.

16. The electrical energy meter of claim 14, wherein the subsystem determines a present portion of the last value, wherein the present portion of the last value is determined based upon the determination of the present portion of the last sample period.

17. The electrical energy meter of claim 14, wherein the subsystem determines a subsequent portion of the last value, wherein the subsequent portion of the last value is determined based upon the determination of the subsequent portion of the last sample period.

18. The electrical energy meter of claim 16, wherein the subsystem adds the present portion of the last value, an intervening value and a previous subsequent portion, wherein the present portion of the last value, the intervening value and the previous subsequent portion are associated with the present accumulation interval, and wherein the intervening value comprises a value determined for an intervening sample, and wherein the intervening sample is associated with an intervening sample period.

19. The electrical energy meter of claim 18, wherein the previous subsequent portion is associated with a previous last sample, and wherein the previous last sample is associated with a previous accumulation interval.

20. The electrical energy meter of claim 16, wherein the subsystem adds the present portion of the last value and a previous subsequent portion, wherein the present portion of the last value and the previous subsequent portion are associated with the present accumulation interval.

21. The electrical energy meter of claim 20, wherein the previous subsequent portion is associated with a previous last sample, and wherein the previous last sample is associated with a previous accumulation interval.
